(19) United States
(12) Patent Application Publication
(10) Pub. No.: US 2017/0217221 A1
(43) Pub. Date: Aug. 3, 2017

(54) RECORDING APPARATUS

(71) Applicant: SEIKO EPSON CORPORATION, Tokyo (JP)

(72) Inventors: Kazuo OTSUKA, Azumino (JP); Tetsuya TAMURA, Matsumoto (JP); Hitoshi IGARASHI, Shiojiri (JP)

(21) Appl. No.: 15/421,105

(22) Filed: Jan. 31, 2017

(30) Foreign Application Priority Data
Feb. 1, 2016 (JP) 2016-017428

(51) Int. Cl. B41J 11/04

(52) U.S. Cl. CPC B41J 11/04

(57) ABSTRACT

A recording apparatus includes a medium storage section that stores a medium, an inverting pathway that bends and inverts medium that has been fed out from the medium storage section, a transport unit that is provided at a position downstream of the inverting pathway and lower than a top portion of the inverting pathway in an apparatus height direction, and that transports medium to a side of a recording section where the medium is recorded on, and a feed-in roller that provides between the inverting pathway and the transport unit, and feeds medium toward a downstream side. At least part of the feed-in roller overlaps with the inverting pathway in the apparatus height direction.

### BACKGROUND

1. Technical Field

The present invention relates to a recording apparatus that records on a medium. In particular, the present invention relates to a recording apparatus including an inverting pathway that bends and inverts a medium fed out from a medium storage section that stores the medium.

2. Related Art

Some recording apparatuses, of which facsimile machines and printers are examples, employ a configuration such as that described in JP-A-2013-100185, including a paper cassette that stores paper, this being an example of a medium, in an apparatus bottom section, and that feeds out paper from the paper cassette, inverts the paper using an inverting roller with a large diameter (the intermediate roller 33 in JP-A-2013-100185), and transports the paper toward a transport unit (the pair of feed-in rollers 40 in JP-A-2013-100185) ahead of a recording head.

The recording apparatus described in JP-A-2013-100185 includes a manual feed path. A manual sheet feed tray configuring the manual feed path (the manual sheet feed tray 50 in JP-A-2013-100185) is disposed at a position directly above the inverting roller and on a rear side of an image reading section. The manual feed path is provided with a load applying mechanism 52 configured by a pair of rollers.

Recently, even greater reductions in size are being demanded of recording apparatuses. However, in configurations such as that of the recording apparatus described in JP-A-2013-100185, which includes the manual feed path in addition to the intermediate roller 33, and is provided with the pair of rollers (the load applying mechanism 52) on the manual feed path, a dimension of the apparatus in the height direction in particular is liable to become large, hampering any reduction in size.

### SUMMARY

An advantage of some aspects of the invention is achieving a further reduction in size in a recording apparatus provided with plural paper feed pathways.

A recording apparatus according to a first aspect of the invention includes: a medium storage section that stores a medium; an inverting pathway that bends and inverts medium that has been fed out from the medium storage section; a transport unit that is provided at a position downstream of the inverting pathway and lower than a top portion of the inverting pathway in an apparatus height direction, and that transports medium to a side of a recording section where the medium is recorded on; and a feed-in roller that provides between the inverting pathway and the transport unit, and feeds medium toward a downstream side. At least part of the feed-in roller overlaps with the inverting pathway in the apparatus height direction.

According to the present aspect, the inverting pathway bends and inverts the medium fed out from the medium storage section, and the feed-in roller that provides between the inverting pathway and the transport unit, and feeds the medium toward the transport unit. At least part of the feed-in roller overlaps with the inverting pathway in the apparatus height direction. Accordingly, in the apparatus height direction dimension, the dimension of the feed-in roller and the dimension of the inverting pathway are not stacked, thereby enabling the apparatus height direction dimension to be suppressed.

According to a second aspect of the invention, the first aspect further includes a carriage configuring the recording section, and including a recording head that records on a medium. At least part of the feed-in roller overlaps with the carriage in the apparatus height direction.

According to the present aspect, at least part of the feed-in roller overlaps in the apparatus height direction with the carriage that configures the recording section, and that includes the recording head that records on the medium. Accordingly, in the apparatus height direction dimension, the dimension of the feed-in roller and the dimension of the carriage are not stacked, thereby enabling the apparatus height direction dimension to be further suppressed.

According to a third aspect of the invention, in the second aspect the entire feed-in roller and the entire inverting pathway are at positions lower than an uppermost portion of the carriage in the apparatus height direction.

According to the present aspect, the entire feed-in roller and the entire inverting pathway are at positions lower than the uppermost portion of the carriage in the apparatus height direction. Accordingly, the roller and the inverting pathway do not project out from the carriage in the apparatus height direction, thereby enabling the apparatus height direction dimension to be further suppressed.

According to a fourth aspect of the invention, any one of the first aspect to the third aspect, further include a medium guide-in pathway that guides the medium fed from above, between the inverting pathway and the transport unit, toward the transport unit. The medium guide-in pathway includes a guide section that guides the medium, and the guide section is provided so as to be detachable from an apparatus body.

According to the present aspect, the medium guide-in pathway includes the guide section that guides the medium. The guide section is provided so as to be detachable from the apparatus body, thereby facilitating unjamming operations when jams occur in the medium guide-in pathway.

According to a fifth aspect of the invention, in the fourth aspect, the inverting pathway is provided to a unit body that is detachable from the apparatus body, and the guide section is provided at an apparatus inner side of the unit body. Removing the unit body exposes the guide section and enables the guide section to be detached from the apparatus body.

According to the present aspect, it is necessary to remove the unit body in order to remove the guide section. Namely, in order to access the apparatus inner side of the guide section, it is necessary to first remove the unit body, and then remove the guide section. Easy access to configuration components inside the apparatus is thereby suppressed, enabling configuration components inside the apparatus to be protected.

According to a sixth aspect of the invention, in either the fourth aspect or the fifth aspect, the guide section configures part of the inverting pathway.

According to the present aspect, the guide section configures not only the medium guide-in pathway, but also part of the inverting pathway. This thereby enables simplification of the apparatus configuration, and enables a reduction in costs.

According to a seventh aspect of the invention, included are: a medium storage section that stores a medium; an inverting pathway that bends and inverts medium that has been fed out from the medium storage section; a transport unit that is provided at a position downstream of the inverting pathway and lower than a top portion of the inverting pathway in an apparatus height direction, and that transports medium toward a side of a recording section where the medium is recorded on; a carriage configuring the recording section, and including a recording head that records on the medium; and a feed-in roller that provides between the inverting pathway and the transport unit, and feeds medium toward a downstream side. At least part of the feed-in roller overlaps with the carriage in the apparatus height direction.

According to the present aspect, the inverting pathway bends and inverts the medium fed out from the medium storage section, and the feed-in roller provide between the inverting pathway and the transport unit, and feeds the medium toward a downstream side. At least part of the feed-in roller overlaps with the carriage in the apparatus height direction. Accordingly, in the apparatus height direction dimension, the dimension of the feed-in roller and the dimension of the carriage are not stacked, thereby enabling the apparatus height direction dimension to be suppressed.

According to an eighth aspect of the invention, the recording apparatus of any one of the first aspect to the seventh aspect, further includes an image reading section that reads an image at an upper section of an apparatus body.

According to the present aspect, the operation and advantageous effects of any one of first aspect to the seventh aspect can be obtained in a configuration including the image reading section that reads an image at the upper section of the apparatus body.

### BRIEF DESCRIPTION OF THE DRAWINGS

The invention will be described with reference to the accompanying drawings, wherein like numbers reference like elements.

FIG. 1 is an external perspective view of a printer according to the invention.

FIG. 2 is a side cross-section illustrating a transport pathway of a medium in a printer according to the invention.

FIG. 3 is a side cross-section illustrating a transport pathway of a medium entering from above a back face side of an apparatus.

FIG. 4 is a side cross-section illustrating a relationship between a directing section and a medium during transportation of the medium.

FIG. 5 is a perspective view of a printer according to the invention, as viewed from a back face side.

FIG. 6 is a perspective view of a unit body including an inverting roller.

FIG. 7 is a perspective view illustrating a back face side of an apparatus body in a state in which a unit body has been removed from the apparatus body.

FIG. 8 is a side cross-section illustrating a transport pathway of a medium in a state in which a unit body has been removed from an apparatus body.

FIG. 9 is an exploded perspective view illustrating a back face side of an apparatus body in a state in which a guide section and a unit body have been removed from the apparatus body.

FIG. 10 is an exploded perspective view illustrating a back face side of an apparatus body in a state in which a guide section and a unit body have been removed from the apparatus body.

FIG. 11 is a side cross-section illustrating a back face side of an apparatus body in a state in which a guide section and a unit body have been removed from the apparatus body.

FIG. 12 is a side cross-section to explain a relationship between a guide section, a directing section, and a medium when reverse-feeding the medium.

### DESCRIPTION OF EXEMPLARY EMBODIMENTS

Explanation follows regarding embodiments of the invention, with reference to the drawings. Note that equivalent configurations in the respective embodiments are allocated the same reference numerals, and are only described in the initial embodiment, with explanation of such configurations being omitted in subsequent embodiments.

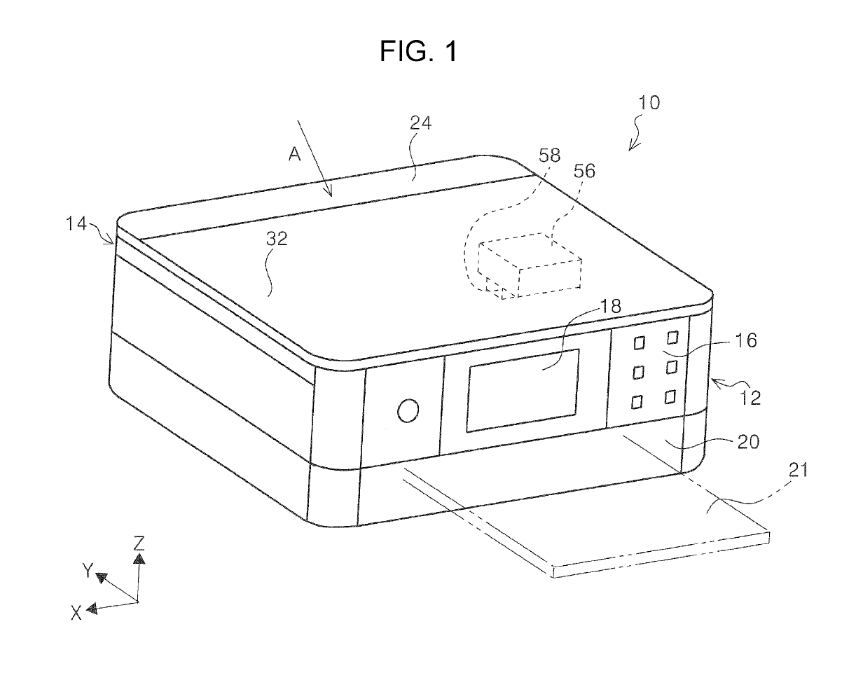

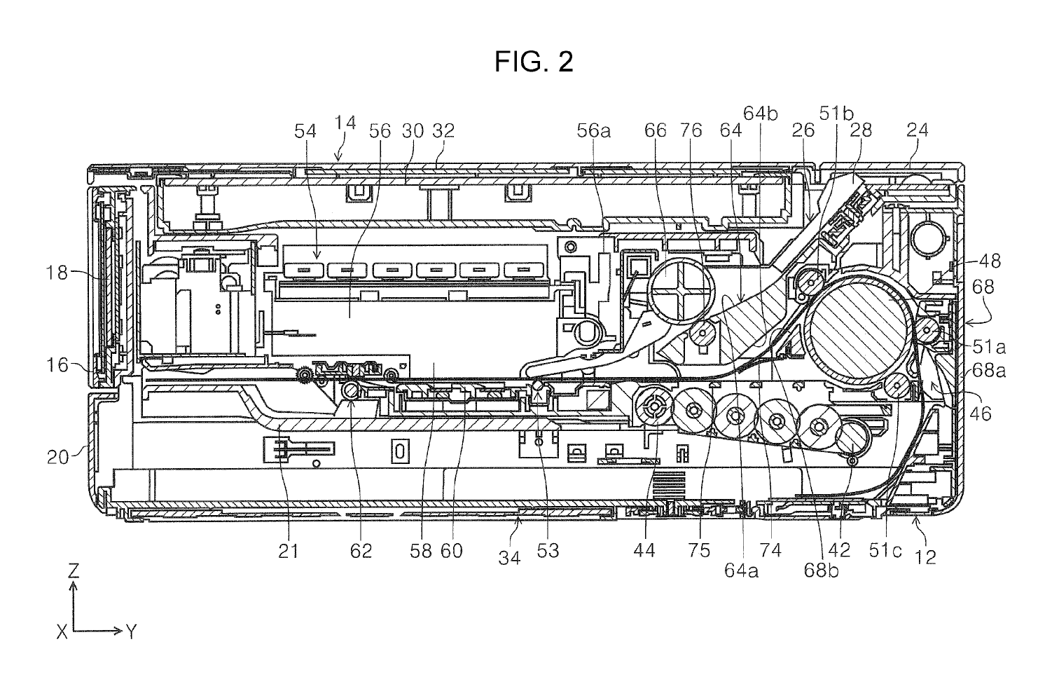

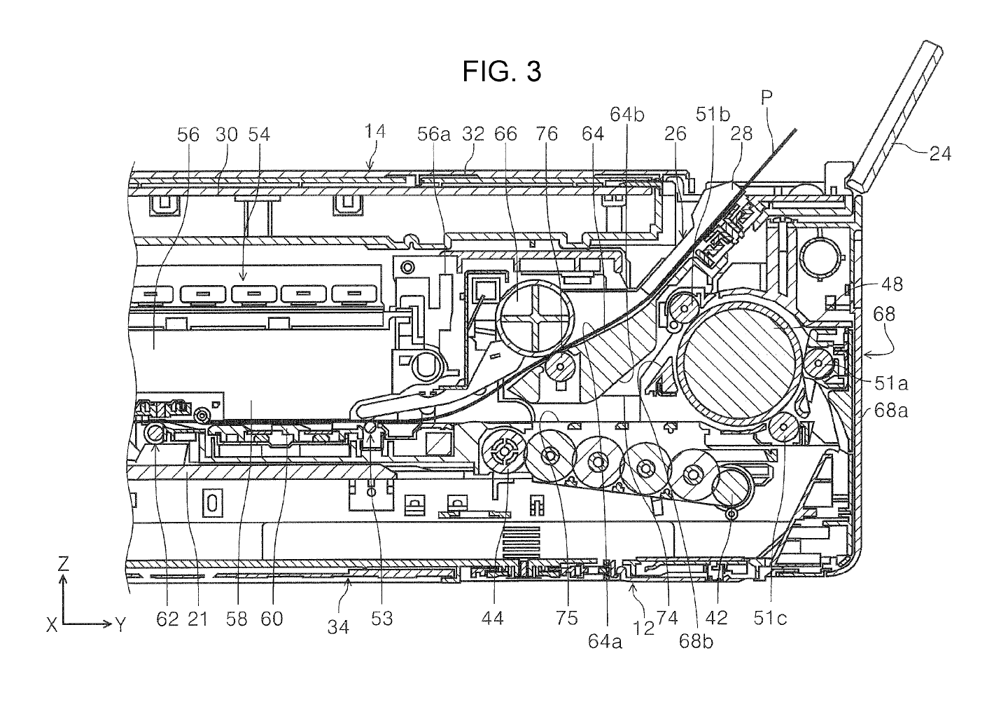

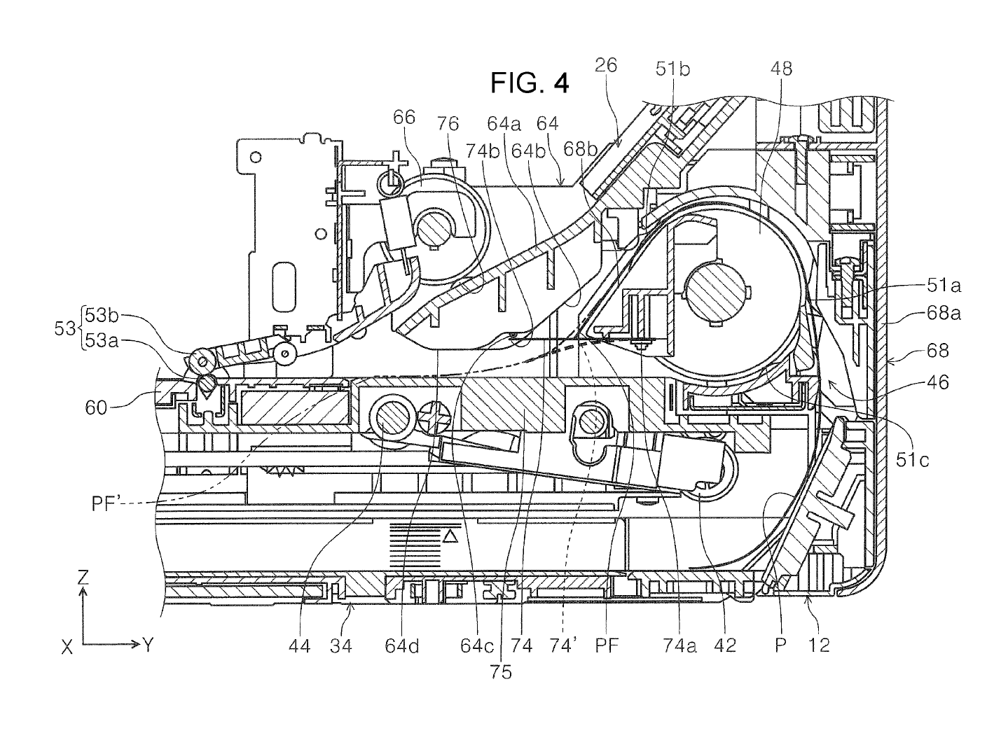

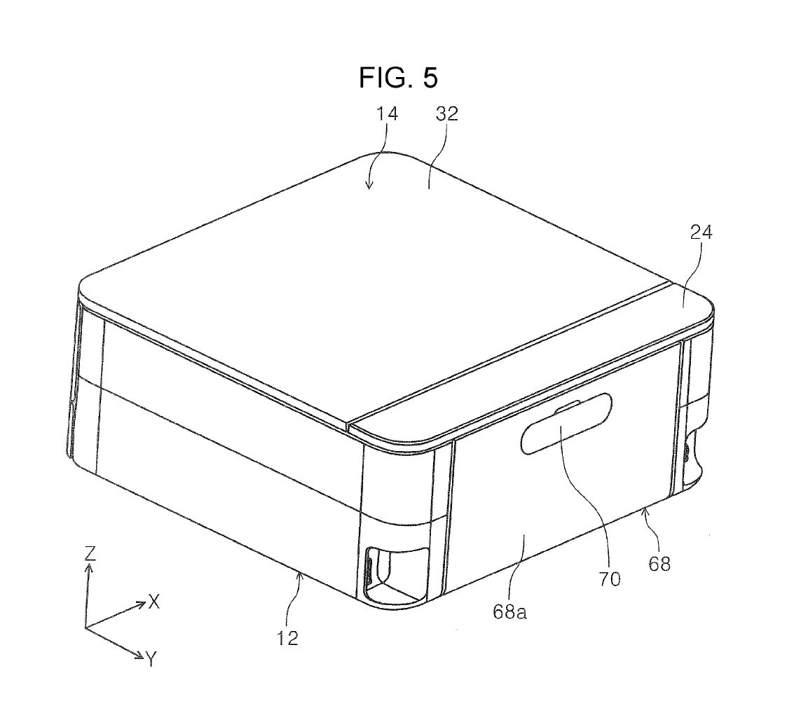

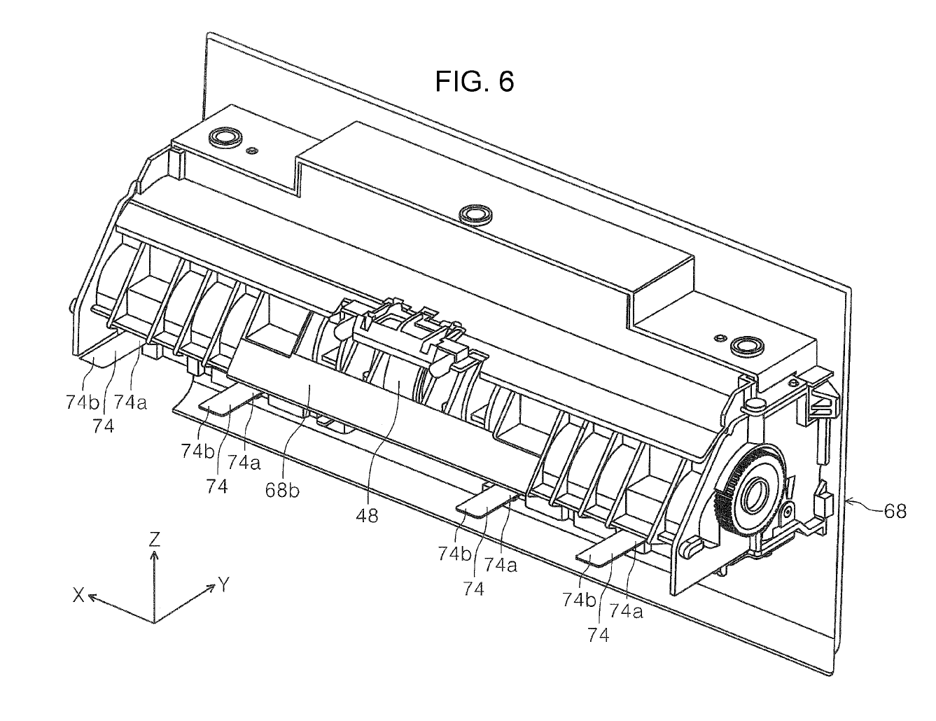

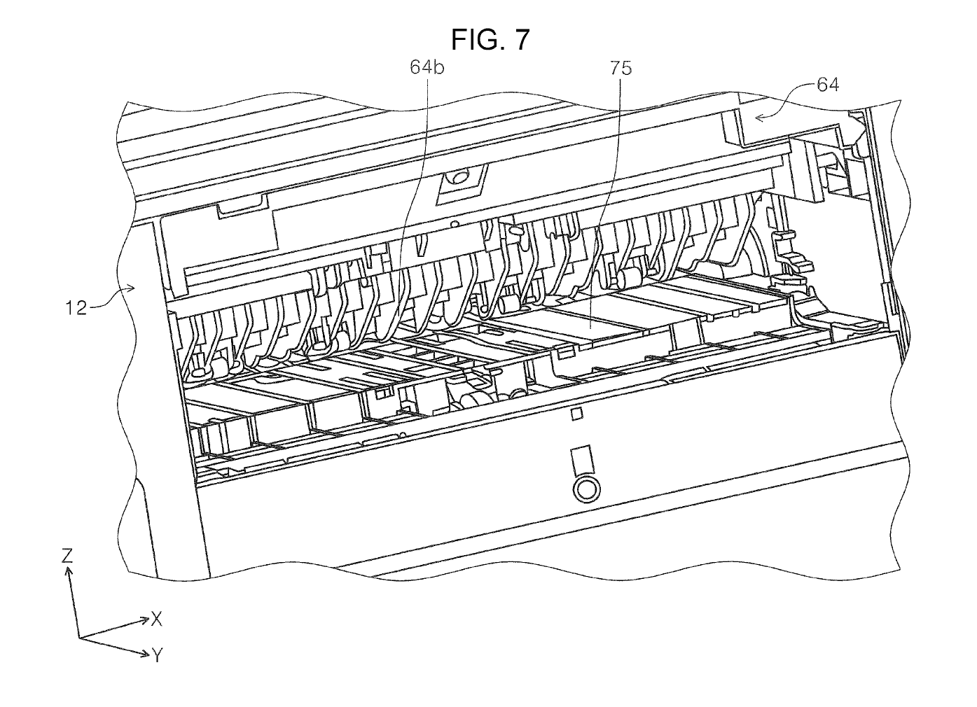

FIG. 1 is an external perspective view of a printer according to the invention. FIG. 2 is a side cross-section illustrating a transport pathway of a medium in a printer according to the invention. FIG. 3 is a side cross-section illustrating a transport pathway of a medium entering from above a back face side of an apparatus. FIG. 4 is a side cross-section illustrating a relationship between a directing section and a medium during transportation of the medium. FIG. 5 is a perspective view of a printer according to the invention, as viewed from a back face side. FIG. 6 is a perspective view of a unit body including an inverting roller. FIG. 7 is a perspective view illustrating a back face side of an apparatus body in a state in which the unit body has been removed from the apparatus body.

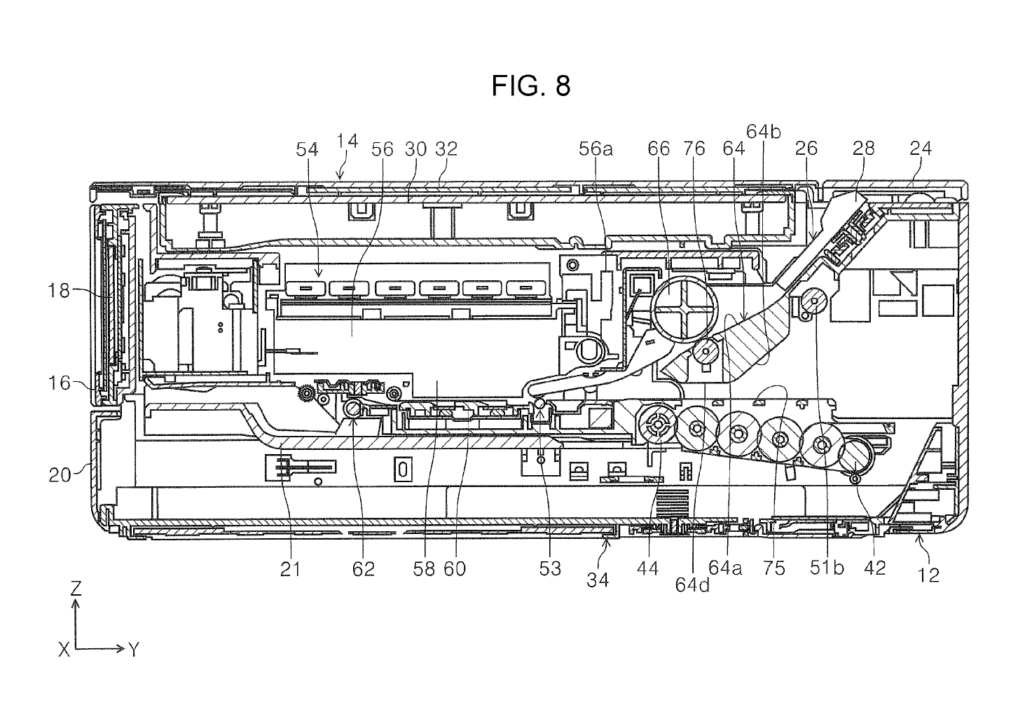

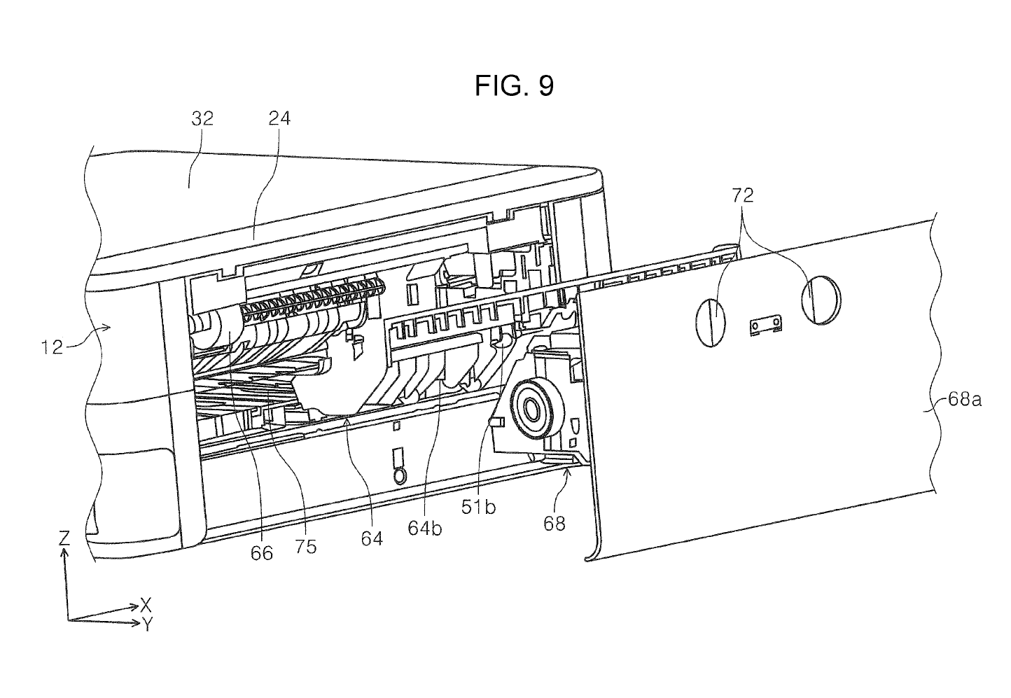

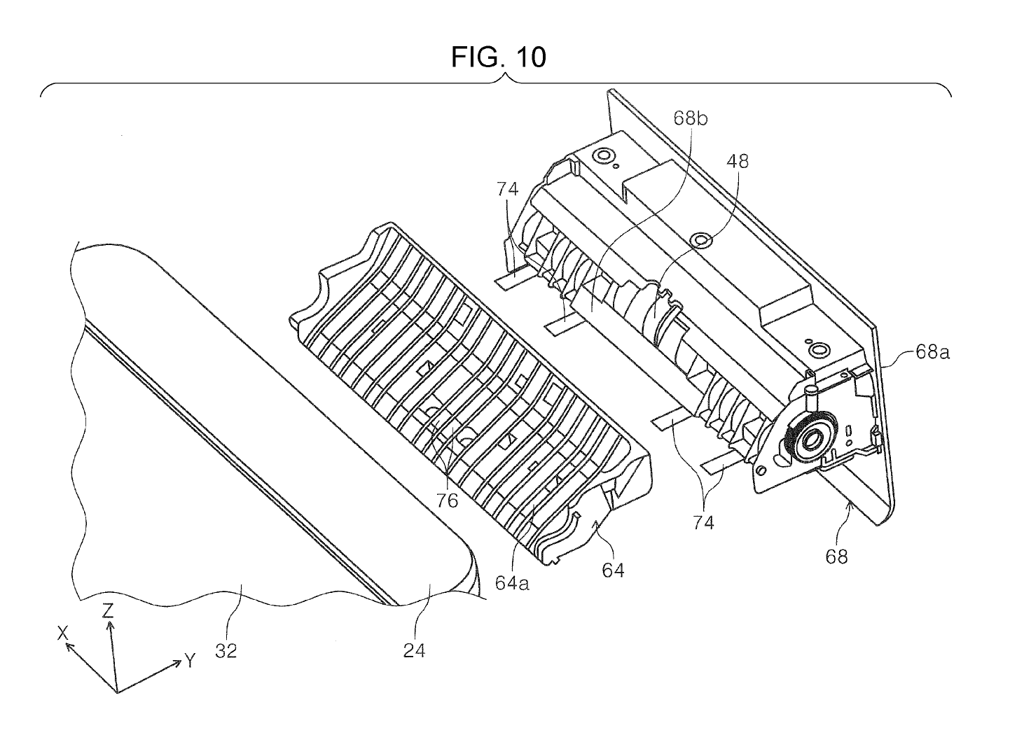

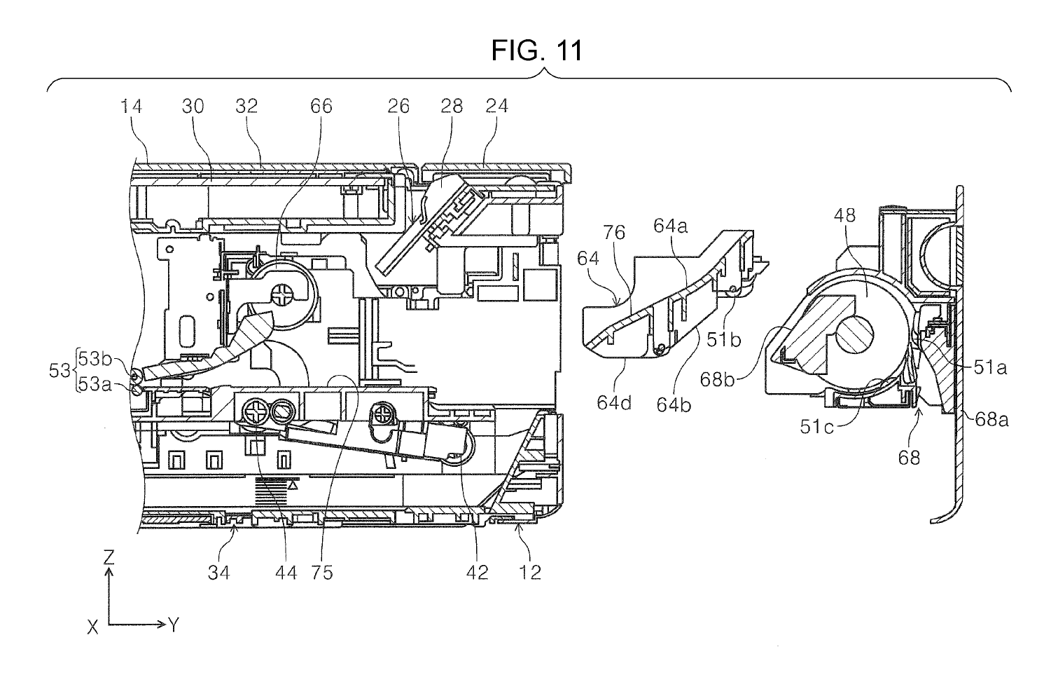

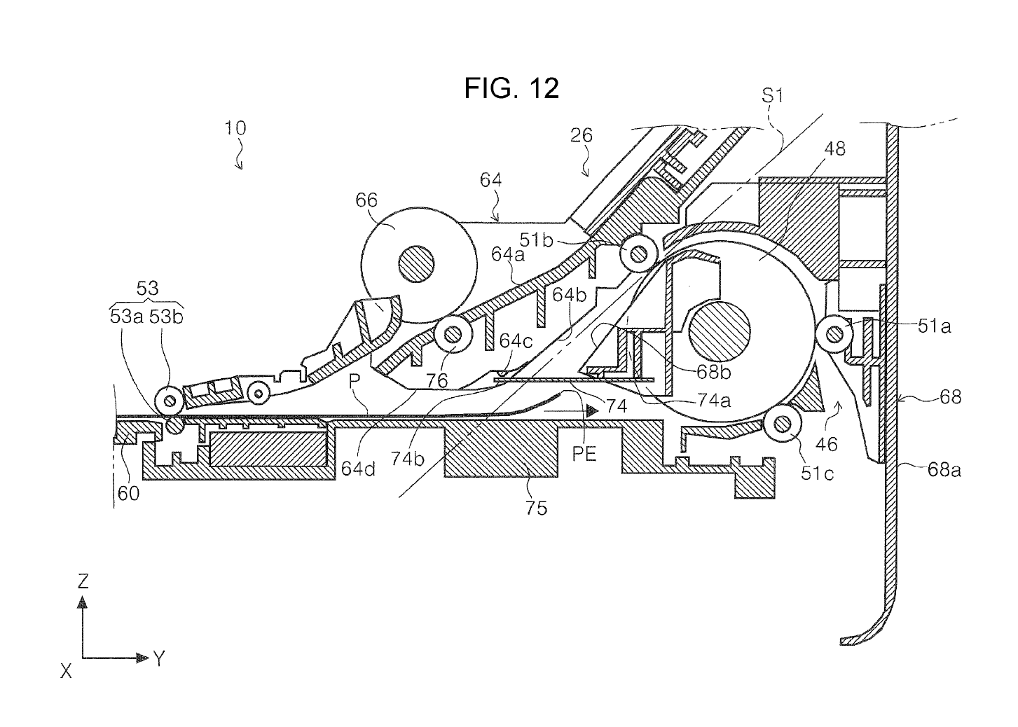

FIG. 8 is a side cross-section illustrating a transport pathway of a medium in a state in which a unit body has been removed from an apparatus body. FIG. 9 is an exploded perspective view illustrating a back face side of an apparatus body in a state in which a guide section and a unit body have been removed from the apparatus body. FIG. 10 is an exploded perspective view illustrating a back face side of an apparatus body in a state in which a guide section and a unit body have been removed from the apparatus body. FIG. 11 is a side cross-section illustrating a back face side of an apparatus body in a state in which a guide section and a unit body have been removed from the apparatus body. FIG. 12 is a side cross-section to explain a relationship between a guide section, a directing section, and a medium when reverse-feeding the medium.

In the X-Y-Z coordinate system used in the respective drawings, the X direction indicates the feed direction of a source document in a feed mechanism of a scanner section, and is also a width direction of the recording apparatus, the Y direction indicates a main scan direction of a read mechanism, and is also a depth direction of the recording apparatus, and the Z direction indicates a height direction of the apparatus. In each of the drawings, a +X direction indicates a left side of the apparatus, a −X direction indicates a right side of the apparatus, a −Y direction indicates a front face side of the apparatus, a +Y direction indicates a back face side of the apparatus, a +Z direction indicates an upper side of the apparatus, and a −Z direction indicates a lower side of the apparatus.

### EMBODIMENT

### Printer Overview

As illustrated in FIG. 1 to FIG. 3, a printer 10 includes an apparatus body 12, and a scanner section 14 (see FIG. 2) serving as an “image reader”. An operation section 16 is provided at an apparatus front face side of the apparatus body 12, so as to be capable of swinging with respect to the apparatus body 12. The operation section 16 is provided with a display 18, such as a display panel.

A cover 20 is disposed below the operation section 16 at the apparatus front face side of the apparatus body 12. The apparatus body 12 is also provided with a paper discharge tray 21. The paper discharge tray 21 is configured to be capable of switching between a stored state inside the apparatus body 12 (see FIG. 2) and an opened out state at the apparatus front face side of the apparatus body 12 (see the region indicated by double-dotted dashed lines in FIG. 1).

A cover 24 is attached to an upper section of the back face side of the apparatus body 12 so as to be capable of swinging. The cover 24 is configured capable of switching between a closed state with respect to the apparatus body 12, illustrated in FIG. 1, and an open state with respect to the apparatus body 12, illustrated in FIG. 3. As illustrated in FIG. 3, when the cover 24 is placed in the open state with respect to the apparatus body 12, a feed-in port 28 of a medium guide-in pathway 26, described later, is exposed. A medium P (see FIG. 3) can be inserted into the feed-in port 28 along the arrow A direction illustrated in FIG. 1.

As illustrated in FIG. 2, the scanner section 14 is provided at an upper section of the apparatus body 12. The scanner section 14 is provided with a document table 30. The document table 30 is, for example, formed from a transparent glass plate, and is configured to enable placement of a source document on an upper face of the document table 30.

The scanner section 14 is further provided with a cover 32 that opens and closes an upper section of the scanner section 14. In a closed state of the cover 32 (see FIG. 1 and FIG. 2), the cover 32 covers the document table 30, and in an open state of the cover 32 (not illustrated in the drawings), the document table 30 is exposed. Namely, the cover 32 is swung with respect to the document table 30 so as to be placed in the open state, exposing the document table 30. A source document is then set on the upper face of the document table 30, and the cover 32 is closed to enable reading of the source document on the document table 30. Note that a reader (not illustrated in the drawings) that is capable of reading the source document set on the document table 30 is provided beneath the document table 30.

### Medium Transport Pathway Overview

Next, explanation follows regarding the transport pathway of the medium in the printer 10, with reference to FIG. 2 to FIG. 4. A medium storage section 34 that stores the medium P is provided in a lower section of the apparatus body 12. In the present embodiment, the medium storage section 34 is configured so as to be detachable from the apparatus body 12 at the front face side of the apparatus. The cover 20 is attached so as to be capable of swinging with respect to the medium storage section 34.

A pick-up roller 42 is provided above the medium storage section 34 at the back face side inside the apparatus body 12. The pick-up roller 42 is configured capable of swinging about a swing shaft 44. The pick-up roller 42 contacts the medium P stored in the medium storage section 34 so as to transport the uppermost sheet of the medium P out of the medium stored in the medium storage section 34 toward a transport direction downstream side along a medium transport pathway 46, serving as an “inverting pathway”. Note that the bold line in FIG. 2 indicates the pathway of the medium P as it is transported along the medium transport pathway 46.

An inverting roller 48 is provided at a downstream side of the pick-up roller 42 on the medium transport pathway 46. Following rollers 51a, 51b and 51c that are capable of rotating so as to follow the inverting roller 48 are provided around the periphery of the inverting roller 48.

The medium P that was fed by the pick-up roller 42 is fed past the inverting roller 48 and the following rollers 51a and 51b to a pair of transport rollers 53, serving as a “transport unit” provided on the transport direction downstream side. As illustrated in FIG. 4, in the present embodiment, the pair of transport rollers 53 includes a transport drive roller 53a that receives drive force from a drive source, not illustrated in the drawings, to drive rotation, and a transport following roller 53b that rotates following the transport drive roller 53a. The pair of transport rollers 53 is provided at a lower position in the apparatus height direction than a top portion of the inverting roller 48.

A recording section 54 is provided at the transport direction downstream side of the pair of transport rollers 53. In the present embodiment, the recording section 54 includes a carriage 56, a recording head 58, and a medium support section 60. In the present embodiment, the carriage 56 is configured capable of moving to and fro in the apparatus width direction. The recording head 58 is provided to a lower section of the carriage 56. In the present embodiment, the recording head 58 is configured so as to eject ink toward the lower side in the apparatus height direction.

The medium support section 60 is provided below the recording head 58 in a region facing the recording head 58. The medium support section 60 supports a lower face (a face on the opposite side to a recording face) of the medium P that has been transported into the region facing the recording head 58 by the pair of transport rollers 53. The recording head 58 ejects ink toward the medium P supported by the medium support section 60 so as to record on the recording face of the medium P.

The medium P on which recording has been performed is nipped by a pair of discharge rollers 62 provided on the transport direction downstream side of the recording section 54, and is discharged toward the paper discharge tray 21 (see FIG. 1) projecting out from the apparatus front face side.

As illustrated in FIG. 3, when the cover 24 provided on the back face side of the apparatus body 12 is in an open position, the feed-in port 28 of the medium guide-in pathway 26 is exposed. The medium guide-in pathway 26 includes a guide section 64 and a feed-in roller 66. In the present embodiment, the medium guide-in pathway 26 is provided between the inverting roller 48 and the pair of transport rollers 53 in the apparatus depth direction. Note that the bold line in FIG. 3 indicates a guide-in pathway of the medium P transported along the medium guide-in pathway 26.

The medium guide-in pathway 26 is configured so as to use the feed-in roller 66 to feed the medium P inserted through the feed-in port 28 between the inverting roller 48 and the pair of transport rollers 53 on the medium transport pathway 46. In the present embodiment, as illustrated in FIG. 3, the feed-in roller 66 is disposed inside the apparatus body 12 such that at least part of the feed-in roller 66 overlaps with the carriage 56 in the apparatus height direction. More specifically, in the present embodiment, the entire feed-in roller 66 and the entire medium transport pathway 46 are positioned at lower positions in the apparatus height direction than an uppermost portion 56a of the carriage 56.

In the present embodiment, the feed-in roller 66 is disposed inside the apparatus body 12 such that at least part of the feed-in roller 66 overlaps with the medium transport pathway 46. Moreover, as illustrated in FIG. 2 and FIG. 3, in the present embodiment, respective parts of the inverting roller 48, the guide section 64, the feed-in roller 66, and the carriage 56 are disposed inside the apparatus body 12 such that they all overlap.

The medium P guided between the inverting roller 48 and the pair of transport rollers 53 in the medium transport pathway 46 is transported to the recording section 54 by the pair of transport rollers 53, is recorded on in the recording section 54, and is discharged toward the paper discharge tray 21 by the pair of discharge rollers 62.

In the present embodiment, the medium guide-in pathway 26 is provided between the inverting roller 48 and the pair of transport rollers 53, thereby enabling the pathway length of the medium guide-in pathway 26 to be shortened, enabling media that are short in length to be accommodated. Moreover, since the feed-in roller 66 is positioned deeper within the apparatus body 12 than the feed-in port 28, media that are short in length, such as business cards and L-sized landscape sets, can be transported with the cover 24 in a closed state after the medium that is short in length has been inserted into the feed-in port 28. This thereby enables the entry of dust or foreign objects into the apparatus body 12 to be suppressed.

After recording on a first face (recording face) of the medium P in the recording section 54, in cases in which recording is also performed on a second face (lower face) on the opposite side to the first face, the transport drive roller 53a is reversed, and the medium P is transported toward the transport direction upstream side. The medium P being transported toward the transport direction upstream side passes beneath the guide section 64 and is nipped between the inverting roller 48 and the following roller 51c. The medium P is then flipped between the first face and the second face by the inverting roller 48, transported to the recording section 54 again, and after the second face has been recorded on in the recording section 54, the medium P is discharged toward the paper discharge tray 21.

### Unit Body and Guide Section

Next, explanation follows regarding a unit body 68 and the guide section 64, with reference to FIG. 2 to FIG. 12. First, explanation follows regarding the unit body 68. As illustrated in FIG. 6 to FIG. 11, the inverting roller 48 and the following rollers 51a and 51c are provided in the unit body 68. The unit body 68 is configured so as to be detachable from the apparatus body 12 at the back face side of the apparatus body 12, as illustrated in FIG. 5.

As illustrated in FIG. 5, a back face side end portion 68a of the unit body 68 configures part of the external profile of the back face side of the apparatus body 12 in a state in which the unit body 68 is attached to the apparatus body 12. A cover 70 is detachably attached to the back face side end portion 68a. As illustrated in FIG. 9, when the cover 70 is removed from the end portion 68a, a pair of lock release levers 72 is exposed. In the present embodiment, in a state in which the unit body 68 is mounted to the apparatus body 12, pressing each of the pair of lock release levers 72 in a direction toward the other, namely in a direction toward the width direction center of the apparatus, releases a locked state of the unit body 68 with respect to the apparatus body 12, and enables removal of the unit body 68 from the apparatus body 12.

An inclined face 68b extending toward an apparatus height direction lower side and an apparatus depth direction front side is provided to an apparatus depth direction front face side of the unit body 68. As illustrated in FIG. 2 to FIG. 4, the inclined face 68b configures part of the medium transport pathway 46 in a state in which the unit body 68 is attached to the apparatus body 12.

As illustrated in FIG. 4 and FIG. 6, plural directing sections 74 projecting out toward the apparatus depth direction front side are provided to a lower end portion of the inclined face 68b of the unit body 68. In the present embodiment, two pairs of the directing sections 74 are provided at intervals in the apparatus width direction. Specifically, a pair of the directing sections 74 toward an apparatus width direction central portion of the unit body 68 are disposed with left-right symmetry about the apparatus width direction center of the unit body 68, and at both apparatus width direction end portions, the other pair of the directing sections 74 are also disposed with left-right symmetry about the apparatus width direction center of the unit body 68.

The directing sections 74 are provided at positions that contact both edges of the medium in the apparatus width direction. In the present embodiment, for example, the pair of the directing sections 74 provided at both apparatus width direction end portions is disposed in the apparatus width direction of the unit body 68 so as to contact both edges of an A4 size medium. This thereby enables curling of the two edges of the medium P toward the apparatus height direction lower side to be corrected, and enables paper jams to be suppressed.

In the present embodiment, the directing sections 74 are configured as sheet shaped members that are capable of elastic deformation. More specifically, as illustrated in FIG. 4, a side of each directing section 74 that opposes the guide section 64 configures a base end side 74a, and the base end side 74a is attached to a lower section of the unit body 68. A leading end side 74b projecting out from the base end side 74a toward the guide section 64 in each directing section 74 configures a free end, and is capable of undergoing deformation. Note that in FIG. 4, the dashed line portion indicated by the reference numeral 74′ illustrates a directing section 74 in which the leading end side 74b has deformed toward the apparatus height direction lower side about the base end side 74a.

### Guide Section

Explanation follows regarding the guide section 64, with reference to FIG. 2 to FIG. 12. The guide section 64 illustrated in FIG. 2 to FIG. 4 is positioned between the inverting roller 48 and the pair of transport rollers 53 in the apparatus depth direction. The guide section 64 narrows a region between the inverting roller 48 and the pair of transport rollers 53 in the apparatus body 12. In the present embodiment, a first guide face 64a forming part of the medium guide-in pathway 26 is provided at the apparatus front face side of the guide section 64. Namely, a medium feed pathway for a medium fed from above in the apparatus height direction is configured between the inverting roller 48 and the pair of transport rollers 53. An apparatus back face side of the guide section 64 is provided with a second guide face 64b that configures part of the medium transport pathway 46 and that serves as a “guide face”.

A following roller 76 that is capable of contacting the feed-in roller 66 is attached to the first guide face 64a so as to be capable of rolling. The following roller 51b that is capable of contacting the inverting roller 48 is provided to the second guide face 64b.

The first guide face 64a extends obliquely downward in the apparatus height direction, and functions as a guide face that guides the medium fed through the feed-in port 28 toward the pair of transport rollers 53. The second guide face 64b extends obliquely downward in the apparatus height direction so as to face the recording face of the medium P when heading away from the inverting roller 48 and toward the pair of transport rollers 53, and functions as a guide face that guides the medium P.

In the present embodiment, the guide section 64 is configured so as to be detachable from the apparatus body 12. When the unit body 68 is detached from the apparatus body 12, as illustrated in FIG. 7 and FIG. 8, the back face side of the guide section 64, namely the second guide face 64b, is exposed to the apparatus depth direction back face side. Namely, the guide section 64 can be accessed from the back face side of the apparatus body 12 by removing the unit body 68 from the apparatus body 12.

Moreover, as illustrated in FIG. 9 to FIG. 11, the guide section 64 can be removed from the back face side of the apparatus body 12. Note that in the present embodiment, configuration is made such that in a state in which the guide section 64 has been removed from the apparatus body 12, the following roller 76 is removed from the apparatus body 12 together with the guide section 64, and the feed-in roller 66 remains on the apparatus body 12 side (see FIG. 11 in particular).

In the present embodiment, due to making configuration such that the feed-in roller 66 remains on the apparatus body 12 side when the guide section 64 is removed from the apparatus body 12, there is no need to disengage a connection with a drive mechanism (not illustrated in the drawings) that transmits drive force to the feed-in roller 66 provided on the apparatus body 12 side. It is thereby possible to avoid increasing the complexity of the apparatus.

If configuration were to be made in which the feed-in roller 66 was removed from the apparatus body 12, there would be a possibility of gear damage as a result of gears colliding with each other when meshing gears provided on the feed-in roller 66 side with gears provided on the drive mechanism side in order to connect the feed-in roller 66 to the drive mechanism. The present embodiment enables such gear damage to be avoided, since there is no need to disengage the connection between the feed-in roller 66 and the drive mechanism.

Moreover, if configuration were to be made in which the feed-in roller 66 was removed from the apparatus body 12, it would not be possible to provide a component to support deflection arising in the feed-in roller 66, and there would be a possibility of medium feed-in errors arising due to positional displacement of the nipping points between the feed-in roller 66 and the following roller 76. In the present embodiment, configuration is made such that the feed-in roller 66 remains on the apparatus body 12 side, enabling a deflection-supporting component to be provided, and suppressing positional displacement of the nipping points between the feed-in roller 66 and the following roller 76. This thereby enables a reduction in medium feed-in errors.

As illustrated in FIG. 11, when the unit body 68 and the guide section 64 are removed from the apparatus body 12, the pair of transport rollers 53 are exposed at the back face side of the apparatus body 12. Namely, the pair of transport rollers 53 can be accessed from the back face side of the apparatus body 12.

Returning once again to FIG. 4, a lower section of the guide section 64 is provided with recessed restriction portions 64c that receive the leading end sides 74b of the directing sections 74. The restriction portions 64c restrict displacement of the leading end sides 74b of the directing sections 74 toward the apparatus height direction upper side in a state in which the unit body 68 is attached to the apparatus body 12. Moreover, the leading end sides 74b of the directing sections 74 extend as far as a position intersecting the second guide face 64b in the apparatus depth direction, and are received by the restriction portion 64c. Moreover, as illustrated in FIG. 12, the directing sections 74 are provided so as to be positioned on a tangent S1 to the inverting roller 48 and the following roller 51b at a contact position (nipping point) between the inverting roller 48 and the following roller 51b.

As illustrated in FIG. 4, when a leading edge PF of the medium P contacts the directing sections 74 (see the solid lines), the leading edge PF presses the directing sections 74 downward in the apparatus height direction, and the leading end sides 74b of the directing sections 74 are displaced toward the apparatus height direction lower side (see the dashed line labeled 74′). When this occurs, the leading edge PF′ of the medium P is pressed by the displaced directing section 74′ and directed toward a direction away from the inverting roller 48, namely toward the apparatus depth direction front side (see the double-dotted dashed line). The angle of the leading edge PF′ of the medium P when it strikes a pathway member 75 (see FIG. 4) can accordingly be made more gentle. This thereby enables the medium P to be transported smoothly from the inverting roller 48 to the pair of transport rollers 53.

Since the directing sections 74 are capable of elastic deformation in the present embodiment, the directing sections 74 undergo elastic deformation so as to enable a space for the medium P to deflect to be secured in order to deflect the medium P between the inverting roller 48 and the pair of transport rollers 53 so as to remove skew after the leading edge PF of the medium P has reached the pair of transport rollers 53.

As illustrated in FIG. 4 and FIG. 12, a lower section of the guide section 64 configures a reverse-feed guide face 64d. The reverse-feed guide face 64d functions as a medium guide face when reverse-feeding the medium from the recording section 54 toward the transport direction upstream side using the pair of transport rollers 53. Note that the directing sections 74 are positioned above the reverse-feed guide face 64d in the apparatus height direction. Moreover, the directing sections 74 block a pathway toward the inclined face 68b side of the medium transport pathway 46 in a state in which the directing sections 74 are not elastically deformed.

As illustrated in FIG. 12, when reverse-feeding the medium P, a rear edge PE of the medium P becomes the leading edge, and the medium P heads toward the transport direction upstream side. When this is performed, the rear edge PE is sometimes transported with a curl toward the apparatus height direction upper side. In the present embodiment, since the directing sections 74 are positioned above the reverse-feed guide face 64d, the possibility of the rear edge PE of the medium P catching can be reduced, even if the rear edge PE is curled toward the apparatus height direction upper side.

The directing sections 74 block the pathway toward the inclined face 68b side of the medium transport pathway 46, and displacement of the leading end sides 74b upward in the apparatus height direction is restricted by the restriction portions 64c. Accordingly, even if the rear edge PE of the medium P were to contact the directing sections 74, the directing sections 74 are not easily pushed up by the rear edge PE of the medium P, thereby enabling the rear edge PE of the medium P, namely the medium P, to be prevented from entering a pathway on the inclined face 68b side. Accordingly, the medium P can be prevented from accidentally entering a pathway other than the reverse-feed pathway, namely a pathway from the pair of transport rollers 53 toward the inclined face 68b side, rather than a pathway from the pair of transport rollers 53 toward the following roller 51c.

### Modified Examples of the Present Embodiment

(1) In the present embodiment, configuration is made in which the directing sections 74 are provided to the unit body 68. However, instead of this configuration, configuration may be made in which the directing sections 74 are provided to the apparatus body 12.

(2) In the present embodiment, configuration is made in which the directing sections 74 are configured as sheet shaped members that are capable of elastic deformation. However, instead of this configuration, configuration may be made in which resin flap members that are biased toward the apparatus height direction upper side by biasing members such as springs are provided to the unit body 68.

(3) In the present embodiment, configuration is made in which the scanner section 14 is provided. However, instead of this configuration, the scanner section 14 may be omitted, and the cover 32 may be attached to an upper section of the apparatus body 12 so as to be capable of swinging.

(4) In the present embodiment, configuration is made in which the guide section 64 and the unit body 68 are respectively detachable from the apparatus body 12. However, instead of this configuration, the guide section 64 and the unit body 68 may be configured as an integral unit configured so as to be detachable from the apparatus body 12.

To summarize the foregoing explanation, the printer 10 includes the medium storage section 34 that stores the medium P, the inverting roller 48 that bends and inverts the medium P fed out from the medium storage section 34, the pair of transport rollers 53 that are provided at a position downstream of the inverting roller 48 and lower than the top portion of the inverting roller 48 in the apparatus height direction, and that transport the medium P toward the side of the recording section 54 that records on the medium P, the guide section 64 that faces the recording face of the medium P heading away from the inverting roller 48 and toward the pair of transport rollers 53, and that includes the second guide face 64b extending in an oblique downward direction, and the directing sections 74 that are provided at a position capable of contacting the leading edge PF of the medium P heading away from the inverting roller 48 and toward the pair of transport rollers 53, and that direct the leading edge PF of the medium P in a direction away from the inverting roller 48.

According to the above configuration, the printer 10 including the inverting roller 48, which bends and inverts the medium P fed out from the medium storage section 34, also includes the guide section 64 and the directing sections 74. The guide section 64 faces the recording face of the medium P heading away from the inverting roller 48 and toward the pair of transport rollers 53, and includes the second guide face 64b extending obliquely downward. The directing sections 74 are provided at a position capable of contacting the leading edge PF of the medium P heading away from the inverting roller 48 and toward the pair of transport rollers 53, and direct the leading edge PF of the medium P in a direction away from the inverting roller 48. The second guide face 64b makes it harder for the trajectory of the medium P away from the inverting roller 48 and toward the pair of transport rollers 53 to be influenced by the medium type or a curled state of the medium leading edge, thereby stabilizing the trajectory of the medium P.

Moreover, in this state, the leading edge PF of the medium P is directed in a direction away from the inverting roller 48 by the directing sections 74. This thereby enables the angle at which the leading edge PF of the medium P strikes the pathway member 75 (a pathway member that is struck by the leading edge PF of the medium P) to be made more gentle, thereby enabling jams resulting from buckling of the leading edge PF of the medium P to be avoided. Namely, the printer 10 including the medium transport pathway 46 that inverts the medium P is capable of achieving more reliable medium transportation.

The directing sections 74 are capable of elastic deformation. Due to this configuration, the directing sections 74 undergo elastic deformation so as to enable a space for the medium P to deflect to be secured in order to deflect the medium P between the inverting roller 48 and the pair of transport rollers 53 so as to correct skew. Namely, appropriate skew correction can be performed.

Each directing section 74 is configured by a sheet shaped member that deforms with the side opposing the guide section 64 as the base end side 74a, and the leading end side 74b projecting out from the base end side 74a toward the guide section 64 as a free end. This configuration enables the directing sections 74 to be configured with a simple structure and at low cost.

A lower face of the guide section 64 configures the reverse-feed guide face 64d that guides the medium P as it is reverse-fed from the pair of transport rollers 53 toward the upstream side. The directing sections 74 are positioned above the reverse-feed guide face 64d. This configuration enables catching of the medium P on the directing sections 74 to be avoided when reverse-feeding the medium P in order to record on both faces of the medium P.

In side view of the medium transport pathway 46, the directing sections 74 extend as far as a position intersecting the second guide face 64b. This configuration enables faults due to the medium P entering an inappropriate pathway to be suppressed, or avoided altogether, when reverse-feeding the medium P in order to record on both faces of the medium P. Note that the “inappropriate pathway” here means a medium transport pathway from the medium storage section 34 toward the pair of transport rollers 53 via the inverting roller 48, namely a pathway toward the inclined face 68b side.

The guide section 64 includes the restriction portions 64c that restrict upward displacement of the leading end sides 74b of the directing sections 74. This configuration enables faults due to the medium P pushing aside the directing sections 74 and entering an inappropriate pathway to be reliably suppressed, or reliably avoided, when reverse-feeding the medium P in order to record on both faces of the medium P. Note that, similarly to above, the “inappropriate pathway” here means a medium transport pathway from the medium storage section 34 toward the pair of transport rollers 53 via the inverting roller 48, namely a pathway toward the inclined face 68b side.

The inverting roller 48 is provided to the unit body 68 that is detachable from the apparatus body 12, and the directing sections 74 may also be provided to the unit body 68. This configuration facilitates maintenance of the directing sections 74.

The inverting roller 48 is provided to the unit body 68 that is detachable from the apparatus body 12, and the directing sections 74 may be provided to the apparatus body 12. This configuration enables easy access to the directing sections 74 by the end user to be suppressed, enabling the directing sections 74 to be protected.

The guide section 64 forms the medium guide-in pathway 26, this being a feed pathway of the medium P when fed from above, between the inverting roller 48 and the pair of transport rollers 53. In this configuration, the guide section 64 forms plural medium feed pathways, thereby enabling a reduction in the cost of the apparatus.

The directing sections 74 are provided at positions that contact both edge portions of the medium P. This configuration enables the occurrence of jams to be reliably suppressed by directing both edge portions of the medium P that are prone to curling.

The following roller 51b is provided contacting the inverting roller 48 so as to rotate following the inverting roller 48, and the directing sections 74 are positioned on the tangent S1 to the inverting roller 48 and the following roller 51b at the contact position between the inverting roller 48 and the following roller 51b in side view of the medium transport pathway 46 of the medium P. This configuration enables the leading edge of the medium P to reliably contact the directing sections 74, and thus enables the occurrence of jams to be reliably suppressed.

To summarize the foregoing explanation, the printer 10 includes the medium storage section 34 that stores the medium P, the medium transport pathway 46 that bends and inverts the medium P that has been fed out from the medium storage section 34, the pair of transport rollers 53 that are provided at a position downstream of the medium transport pathway 46 and lower than a top portion of the medium transport pathway 46 in the apparatus height direction, and that transport the medium P toward the side of the recording section 54 that records on the medium P, and the medium guide-in pathway 26 that guides the medium P fed from above, between the medium transport pathway 46 and the pair of transport rollers 53, toward the pair of transport rollers 53. The medium guide-in pathway 26 includes the feed-in roller 66 that feeds the medium P toward the downstream side. At least part of the feed-in roller 66 overlaps with the medium transport pathway 46 in the apparatus height direction.

According to the above configuration, the printer 10 includes the medium transport pathway 46 that bends and inverts the medium P when fed out from the medium storage section 34, and the medium guide-in pathway 26 that guides the medium P when fed from above, between the medium transport pathway 46 and the pair of transport rollers 53, toward the pair of transport rollers 53. At least part of the feed-in roller 66 provided to the medium guide-in pathway 26 overlaps with the medium transport pathway 46 in the apparatus height direction. Accordingly, in the apparatus height direction dimension, the dimension of the feed-in roller 66 and the dimension of the medium transport pathway 46 are not stacked, thereby enabling the apparatus height direction dimension to be suppressed.

The printer 10 includes the carriage 56 that configures the recording section 54 and that includes the recording head 58 that records on the medium P. At least part of the feed-in roller 66 overlaps with the carriage 56 in the apparatus height direction. In this configuration, in the apparatus height direction dimension, the dimension of the feed-in roller 66 and the dimension of the carriage 56 are not stacked, thereby enabling the apparatus height direction dimension to be further suppressed.

The entire feed-in roller 66 and the entire medium transport pathway 46 are at positions lower than the uppermost portion 56a of the carriage 56 in the apparatus height direction. In this configuration, the feed-in roller 66 and the medium transport pathway 46 do not project out from the carriage 56 in the apparatus height direction, thereby enabling the apparatus height direction dimension to be further suppressed.

The medium guide-in pathway 26 includes the guide section 64 that guides the medium P. The guide section 64 is provided so as to be detachable from the apparatus body 12. This configuration facilitates unjamming operations when jams occur in the medium guide-in pathway 26.

The medium transport pathway 46 is provided to the unit body 68 that is detachable from the apparatus body 12, and the guide section 64 is provided at an apparatus inner side of the unit body 68. Removing the unit body 68 exposes the guide section 64, and enables the guide section 64 to be detached from the apparatus body 12. In this configuration, it is necessary to remove the unit body 68 in order to remove the guide section 64. Namely, in order to access the apparatus inner side of the guide section 64, it is necessary to first remove the unit body 68, and then remove the guide section 64. Easy access to configuration components inside the apparatus is thereby suppressed, enabling configuration components inside the apparatus to be protected.

The guide section 64 configures part of the medium transport pathway 46. This configuration enables simplification of the apparatus configuration, and enables a reduction in costs.

The printer 10 includes the medium storage section 34 that stores the medium P, the medium transport pathway 46 that bends and inverts the medium P fed out from the medium storage section 34, the pair of transport rollers 53 that are provided at a position downstream of the medium transport pathway 46 and lower than the top portion of the medium transport pathway 46 in the apparatus height direction, and that transport the medium P toward the side of the recording section 54 that records on the medium P, the carriage 56 including the recording head 58 that configures the recording section 54 and that records on the medium P, and the medium guide-in pathway 26 that guides the medium P fed from above, between the medium transport pathway 46 and the pair of transport rollers 53, toward the pair of transport rollers 53. The medium guide-in pathway 26 includes the feed-in roller 66 that feeds the medium P toward the downstream side. At least part of the feed-in roller 66 overlaps with the carriage 56 in the apparatus height direction.

This configuration of the printer 10 includes the medium transport pathway 46 that bends and inverts the medium P when fed out from the medium storage section 34, and the medium guide-in pathway 26 that guides the medium P when fed from above, between the medium transport pathway 46 and the pair of transport rollers 53, toward the pair of transport rollers 53. At least part of the feed-in roller 66 provided to the medium guide-in pathway 26 overlaps with the carriage 56 in the apparatus height direction. Accordingly, in the apparatus height direction dimension, the dimension of the feed-in roller 66 and the dimension of the carriage 56 are not stacked, thereby enabling the apparatus height direction dimension to be suppressed.

The image reading scanner section 14 is provided to the upper section of the apparatus body 12. This configuration enables the above operation and advantageous effects to be achieved in a configuration in which the image reading scanner section 14 is provided to the upper section of the apparatus body 12.

To summarize the foregoing explanation, the printer 10 includes the medium storage section 34 that stores the medium P, the inverting roller 48 that bends and inverts the medium P fed out from the medium storage section 34, and the pair of transport rollers 53 that are provided at a position downstream of the inverting roller 48 and lower than the top portion of the inverting roller 48 in the apparatus height direction, and that transport the medium toward the side of the recording section 54 that records on the medium P. The inverting roller 48 is provided to the unit body 68 so as to be detachable from the apparatus body 12. The guide section 64 that narrows a space between the pair of transport rollers 53 and the inverting roller 48 inside the apparatus and that forms a pathway of the medium P being transported from the inverting roller 48 toward the pair of transport rollers 53 is provided between the pair of transport rollers 53 and the inverting roller 48. The guide section 64 is exposed and becomes detachable from the apparatus body 12 when the unit body 68 is removed.

In the above configuration, the guide section 64 that narrows the space between the pair of transport rollers 53 and the inverting roller 48 inside the apparatus and that forms a pathway of the medium P being transported from the inverting roller 48 toward the pair of transport rollers 53 is provided between the pair of transport rollers 53 and the inverting roller 48. This thereby enables the medium P to be stably transported from the inverting roller 48 toward the pair of transport rollers 53. At the same time, easy access to the inside of the apparatus is suppressed, enabling the configuration components inside the device to be protected.

The guide section 64 is detachable, thereby facilitating clearage of jams occurring at positions deep inside the apparatus. Moreover, in order to attach or detach the guide section 64, it is necessary to first remove the unit body 68, thereby enabling access to positions deep inside the apparatus to be suppressed to a minimum. This thereby enables both easy clearage when jams occur at positions deep inside the apparatus, while suppressing easy access to positions deep inside the apparatus.

The medium guide-in pathway 26 is provided to guide the medium P fed from above, between the inverting roller 48 and the pair of transport rollers 53, toward the pair of transport rollers 53, and the guide section 64 configures the medium guide-in pathway 26. In this configuration, the guide section 64 configures not only the medium transport pathway 46 reaching from the inverting roller 48 to the pair of transport rollers 53, but also the medium guide-in pathway 26 of the medium fed from above, between the inverting roller 48 and the pair of transport rollers 53. This thereby enables a reduction in the number of components, and enables a reduction in costs.

The medium guide-in pathway 26 includes the feed-in roller 66 that feeds the medium P toward the downstream side, and the following roller 76 that nips the medium against the feed-in roller 66 and that rotates following the feed-in roller 66. Configuration is made such that the following roller 76 is provided so as to be detachable from the apparatus body 12 together with the guide section 64, and the feed-in roller 66 remains with the apparatus body 12 in a state in which the guide section 64 and the following roller 76 have been removed from the apparatus body 12. In this configuration, the feed-in roller 66 remains with the apparatus body 12 in a state in which the guide section 64 and the following roller 76 have been removed from the apparatus body 12, and so, for example, there is no need to disconnect a drive system for driving rotation of the feed-in roller 66. This is preferable from various perspectives, for example since there is no need to mesh together or release meshing between gears.

Access to the pair of transport rollers 53 becomes possible in a state in which the unit body 68 and the guide section 64 have been removed from the apparatus body 12. This configuration suppresses easy access to the pair of transport rollers 53, thereby enabling the pair of transport rollers 53 to be protected.

The printer 10 includes the carriage 56 configuring the recording section 54 and including the recording head 58 that records on the medium P. Respective parts of the inverting roller 48, the guide section 64, the feed-in roller 66, and the carriage 56 all overlap with each other in the apparatus height direction. This configuration suppresses the apparatus height direction dimension, thereby enabling a reduction in the size of the apparatus.

The entire disclosure of Japanese Patent Application No. 2016-017428, filed Feb. 1, 2016 is expressly incorporated by reference herein.

What is claimed is:

1. A recording apparatus comprising:
a medium storage section that stores a medium;
an inverting pathway that inverts medium that has been fed out from the medium storage section;
a transport unit that is provided at a position downstream of the inverting pathway and lower than a top portion of the inverting pathway in an apparatus height direction, and that transports medium to a recording section where the medium is recorded on; and
a feed-in roller that provides between the inverting pathway and the transport unit, and feeds the medium toward a downstream side,
with at least part of the feed-in roller overlapping with the inverting pathway in the apparatus height direction.

2. The recording apparatus of claim 1, further comprising a carriage configuring the recording section, and including a recording head that records on a medium, wherein
at least part of the feed-in roller overlaps with the carriage in the apparatus height direction.

3. The recording apparatus of claim 2, wherein the entire feed-in roller and the entire inverting pathway are at positions lower than an uppermost portion of the carriage in the apparatus height direction.

4. The recording apparatus of claim 1, further comprising a medium guide-in pathway that guides the medium fed from above, between the inverting pathway and the transport unit, toward the transport unit, wherein:
the medium guide-in pathway includes a guide section that guides the medium; and
the guide section is provided so as to be detachable from an apparatus body.

5. The recording apparatus of claim 4, wherein:
the inverting pathway is provided to a unit body that is detachable from the apparatus body;
the guide section is provided at an apparatus inner side of the unit body; and
removing the unit body exposes the guide section and enables the guide section to be detached from the apparatus body.

6. The recording apparatus of claim 4, wherein the guide section configures part of the inverting pathway.

7. A recording apparatus comprising:
a medium storage section that stores a medium;
an inverting pathway that inverts medium that has been fed out from the medium storage section;
a transport unit that is provided at a position downstream of the inverting pathway and lower than a top portion of the inverting pathway in an apparatus height direction, and that transports medium toward a side of a recording section where the medium is recorded on;
a carriage configuring the recording section, and including a recording head that records on the medium;
a feed-in roller that provides between the inverting pathway and the transport unit, and feeds medium toward a downstream side,
with at least part of the feed-in roller overlapping with the carriage in the apparatus height direction.

8. The recording apparatus of claim 1, further comprising an image reading section that reads an image at an upper section of an apparatus body.
